(19) United States
(12) Patent Application Publication
(10) Pub. No.: US 2025/0020808 A1
(43) Pub. Date: Jan. 16, 2025

(54) INFORMATION PROCESSING DEVICE AND INFORMATION PROCESSING METHOD

(71) Applicant: SONY GROUP CORPORATION, TOKYO (JP)

(72) Inventors: YIWEN ZHU, TOKYO (JP); KAZUNORI KAMIO, TOKYO (JP)

(21) Appl. No.: 18/714,244

(22) PCT Filed: Nov. 25, 2022
(86) PCT No.: PCT/JP2022/043549

§ 371 Date: May 29, 2024

(30) Foreign Application Priority Data
Dec. 6, 2021 (JP) 2021-197830

(51) Int. Cl. G01S 17/894; G01S 7/4861

(52) U.S. Cl. CPC G01S 17/894; G01S 7/4861

(57) ABSTRACT

To achieve prevention of degradation in accuracy in distance measurement. An information processing device includes a distance data generation unit, an object boundary detection unit, and a correction unit. The distance data generation unit generates the time-of-flight data group including a plurality of pieces of time-of-flight data formed at predetermined distance intervals, each of the plurality of pieces of time-of-flight data being generated based on a time of flight detected based on reflected light emitted from a light source and reflected from a subject and having a configuration in which a detection frequency of the time of flight at a corresponding distance is reflected for each pixel. The object boundary detection unit detects a boundary of an object based on the time-of-flight data group. The correction unit corrects the time-of-flight data group based on the detected boundary of the object.

### FIELD

The present disclosure relates to an information processing device and an information processing method.

### BACKGROUND

There is a known distance measuring device that measures a distance to a target object by a Time of Flight (ToF) method, which measures a distance to the target object by irradiating the target object with light, receiving reflected light, which is light reflected by the target object, and detecting a time of flight of the light. Regarding the distance measuring device, there has been proposed a distance measuring device that uses a laser diode as a light source and adjusts output of the laser diode to prevent degradation of accuracy (refer to Patent Literature 1, for example).

### CITATION LIST

### Patent Literature

Patent Literature 1: JP 2017-020841 A

### SUMMARY

### Technical Problem

However, the above-described conventional technique does not include removal of the influence of scattering in the atmosphere and a blur due to Modulation Transfer Function (MTF) of a lens arranged in the light receiving unit, which are received until reflected light from the target object reaches a light receiving unit of the distance measuring device. This leads to a problem of degradation of distance measurement accuracy due to scattering of light.

In view of this, the present disclosure proposes an information processing device and an information processing method capable of preventing degradation in distance measurement accuracy.

### Solution to Problem

An information processing device according to the present disclosure includes: a distance data generation unit that generates a time-of-flight data group including a plurality of pieces of time-of-flight data formed at predetermined distance intervals, each of the plurality of pieces of time-of-flight data being generated based on a time of flight detected based on reflected light emitted from a light source and reflected from a subject and having a configuration in which a detection frequency of the time of flight at a corresponding distance is reflected for each pixel; an object boundary detection unit that detects a boundary of an object based on the time-of-flight data group; and a correction unit that corrects the time-of-flight data group based on the detected boundary of the object.

An information processing method according to the present disclosure includes: generating a time-of-flight data group including a plurality of pieces of time-of-flight data formed at predetermined distance intervals, each of the plurality of pieces of time-of-flight data being generated based on a time of flight detected based on reflected light emitted from a light source and reflected from a subject and having a configuration in which a detection frequency of the time of flight at a corresponding distance is reflected for each pixel; detecting a boundary of an object based on the time-of-flight data group; and correcting the time-of-flight data group based on the detected boundary of the object.

### BRIEF DESCRIPTION OF DRAWINGS

FIG. 1 is a diagram illustrating a configuration example of a distance measuring device according to an embodiment of the present disclosure.

FIG. 2A is a diagram illustrating an example of a time-of-flight data group according to the embodiment of the present disclosure.

FIG. 2B is a diagram illustrating time-of-flight data according to the embodiment of the present disclosure.

FIG. 3A is a diagram illustrating an example of a time-of-flight histogram according to the embodiment of the present disclosure.

FIG. 3B is a diagram illustrating time-of-flight data according to the embodiment of the present disclosure.

FIG. 4A is a diagram illustrating an example of distance measurement according to the embodiment of the present disclosure.

FIG. 4B is a diagram illustrating an example of distance measurement according to the embodiment of the present disclosure.

FIG. 5 is a diagram illustrating a configuration example of an object boundary detection unit according to a first embodiment of the present disclosure.

FIG. 6A is a diagram illustrating an example of object boundary detection according to the first embodiment of the present disclosure.

FIG. 6B is a diagram illustrating an example of object boundary detection according to the first embodiment of the present disclosure.

FIG. 7A is a diagram illustrating an example of object boundary detection according to the first embodiment of the present disclosure.

FIG. 7B is a diagram illustrating an example of object boundary detection according to the first embodiment of the present disclosure.

FIG. 8 is a diagram illustrating an example of correction according to the first embodiment of the present disclosure.

FIG. 9 is a diagram illustrating an example of a processing procedure in information processing according to the first embodiment of the present disclosure.

FIG. 10 is a diagram illustrating an example of a processing procedure regarding object region detection processing according to the first embodiment of the present disclosure.

FIG. 11 is a diagram illustrating an example of a processing procedure regarding object boundary detection processing according to the first embodiment of the present disclosure.

FIG. 12 is a diagram illustrating a configuration example of an object boundary detection unit according to a second embodiment of the present disclosure.

FIG. 13 is a diagram illustrating an example of object detection according to the second embodiment of the present disclosure.

FIG. 14A is a diagram illustrating an example of foreground/background determination according to the second embodiment of the present disclosure.

FIG. 14B is a diagram illustrating an example of object boundary detection according to the second embodiment of the present disclosure.

FIG. 15 is a diagram illustrating a configuration example of an object boundary detection unit according to a third embodiment of the present disclosure.

FIG. 16 is a diagram illustrating a configuration example of a correction unit according to a fourth embodiment of the present disclosure.

FIG. 17 is a diagram illustrating an example of classification and filtering according to the fourth embodiment of the present disclosure.

### DESCRIPTION OF EMBODIMENTS

Embodiments of the present disclosure will be described below in detail with reference to the drawings. The description will be given in the following order. Note that, in each of the following embodiments, the same parts are denoted by the same reference symbols, and a repetitive description thereof will be omitted.
1. First Embodiment
2. Second Embodiment
3. Third Embodiment
4. Fourth Embodiment

### 1. First Embodiment

### [Configuration of Distance Measuring Device]

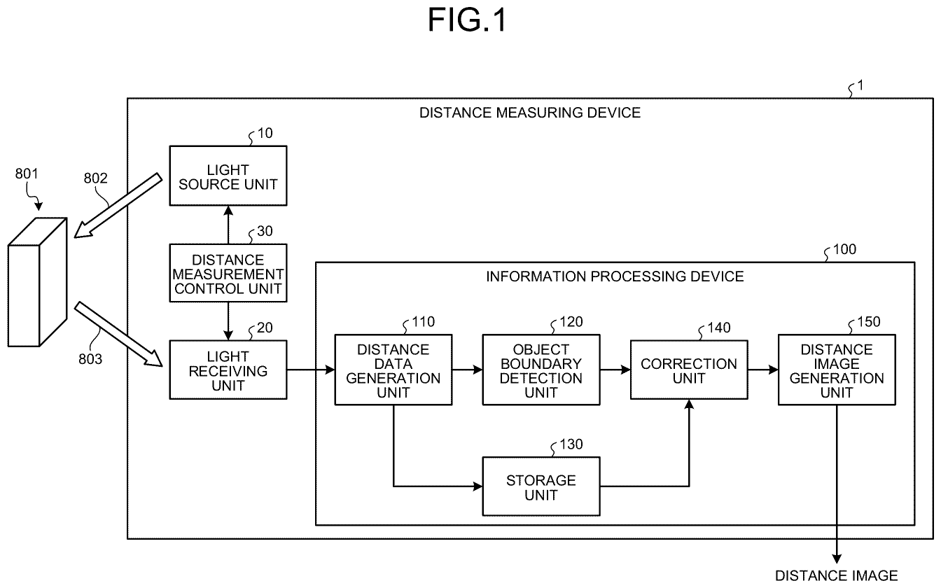

FIG. 1 is a diagram illustrating a configuration example of a distance measuring device according to an embodiment of the present disclosure. The drawing is a block diagram illustrating the configuration example of a distance measuring device 1. The distance measuring device 1 is a device that measures a distance to a target object. Specifically, the device emits light to the target object, detects light reflected by the target object, and measures a time of flight being a time from emission of the light to the target object to incidence of the reflected light, thereby measuring the distance to the target object. This drawing illustrates a case where the distance to a target object 801 is measured. In the drawing, the distance measuring device 1 irradiates the target object 801 with emission light 802 and detects reflected light 803.

A light source unit 10 emits light, as emission light (emission light 802), to a target object. The light source unit 10 can be implemented by using a laser diode, for example.

A light receiving unit 20 detects reflected light (reflected light 803) from the target object. The light receiving unit 20 includes a pixel array unit including a matrix of a plurality of light receiving pixels having light receiving elements that detect reflected light. The light receiving element can be implemented by using a single photon avalanche diode (SPAD). Furthermore, the light receiving unit 20 generates a histogram representing the detection frequency of the time of flight as a degree for each class of a predetermined time width for each light receiving pixel, and outputs the generated histogram as distance measurement data. The histogram is formed by integrating the detection frequencies of the plurality of reflected light beams accompanying the emission of a plurality of emitted light beams. Note that the light receiving unit 20 can include a lens that condenses reflected light.

A distance measurement control unit 30 controls the light source unit 10 and the light receiving unit 20 to perform distance measurement. The distance measurement control unit 30 controls the light source unit 10 to emit laser light and notifies the light receiving unit 20 of an emission timing. The light receiving unit 20 measures the time of flight based on this notification.

An information processing device 100 processes distance measurement data output from the light receiving unit 20. The information processing device 100 in the drawing generates and outputs a distance image from the distance measurement data. Here, the distance image is an image in which distance information is reflected for each pixel of the image. For example, an image color-coded according to the distance corresponds to the distance image.

The information processing device 100 includes a distance data generation unit 110, a storage unit 130, an object boundary detection unit 120, a correction unit 140, and a distance image generation unit 150.

The distance data generation unit 110 generates a time-of-flight data group from distance measurement data output from the light receiving unit 20. Here, the time-of-flight data group is a data group including a plurality of pieces of time-of-flight data in which the detection frequency of the time-of-flight is reflected for each pixel, formed at predetermined distance intervals. Details of the time-of-flight data group will be described below. The distance data generation unit 110 outputs the generated time-of-flight data group to the object boundary detection unit 120 and the storage unit 130.

The storage unit 130 holds the time-of-flight data group output from the distance data generation unit 110.

The object boundary detection unit 120 detects the boundary of the object based on the time-of-flight data group output from the distance data generation unit 110. Details of the object boundary detection unit 120 will be described below.

The correction unit 140 corrects the time-of-flight data group based on the object boundary detected by the object boundary detection unit 120. The correction unit 140 in the drawing corrects the time-of-flight data group held in the storage unit 130 and outputs the corrected time-of-flight data group to the distance image generation unit 150. Details of the correction will be described below.

The distance image generation unit 150 generates the above-described distance image based on the time-of-flight data corrected by the correction unit 140. The generated distance image is output to an external device or the like.

### [Configuration of Time-of-Flight Data Group]

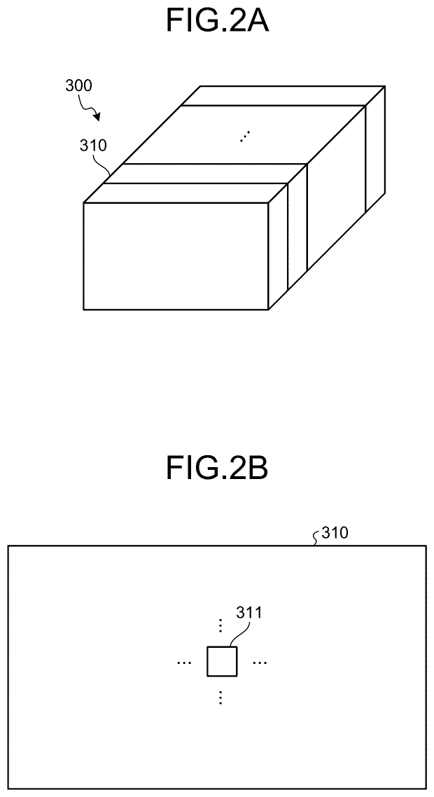

FIG. 2A is a diagram illustrating an example of a time-of-flight data group according to the embodiment of the present disclosure. A time-of-flight data group 300 in the drawing has a plurality of pieces of time-of-flight data 310. The time-of-flight data 310 included in the time-of-flight data group 300 is arranged in time series. Furthermore, the pixel of each piece of the time-of-flight data 310 stores a detection frequency of a corresponding class width (bin width) of the time-of-flight histogram. The time-of-flight data group 300 is three-dimensional data expanding in the X, Y, and depth directions.

FIG. 2B is a diagram illustrating time-of-flight data according to the embodiment of the present disclosure. The time-of-flight data 310 stores data of a plurality of pixels. A pixel 311 in the drawing stores the frequency of the class corresponding to the time-of-flight data 310 of the histogram of the pixel in the light receiving unit 20 corresponding to the pixel. The frequency of this class corresponds to the detection frequency of the time of flight.

### [Configuration of Time-of-Flight Histogram]

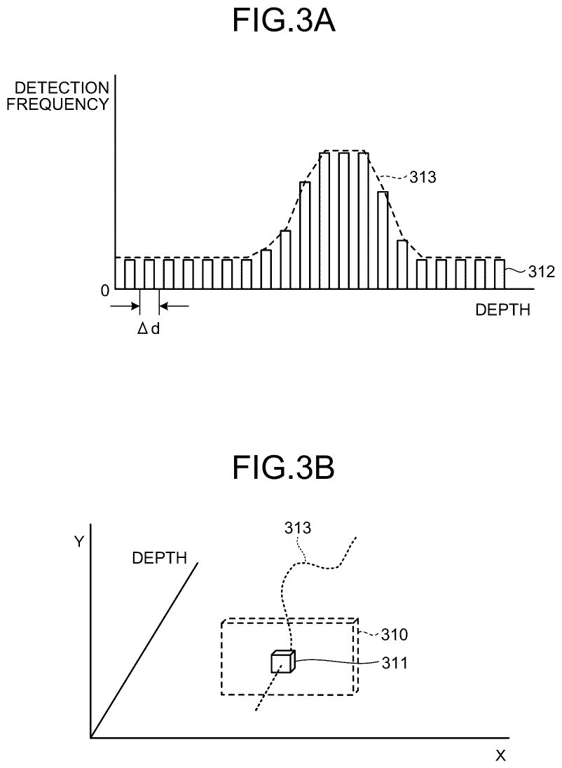

FIG. 3A is a diagram illustrating an example of a time-of-flight histogram according to the embodiment of the present disclosure. The drawing is a diagram illustrating an example of a histogram generated by the light receiving unit 20. The histogram in the drawing is a graph in which a detection frequency degree 312 of a class width Δd is arranged over the detection range of the time of flight. The horizontal axis in the drawing represents the depth direction of the time-of-flight data group 300 illustrated in FIG. 2A. This depth direction corresponds to time of flight. The drawing further includes a histogram 313 represented by a polygonal line.

FIG. 3B is a diagram illustrating time-of-flight data according to the embodiment of the present disclosure. This drawing illustrates time-of-flight data 310 extracted from the time-of-flight data group 300. The detection frequency of one class of the histogram 313 is stored in the pixel 311 of the time-of-flight data 310. Such a pixel is arranged in plurality in the X and Y directions. Time-of-flight data similar to the time-of-flight data 310 is arranged in time series in the depth direction to constitute the time-of-flight data group 300.

### [Distance Measurement]

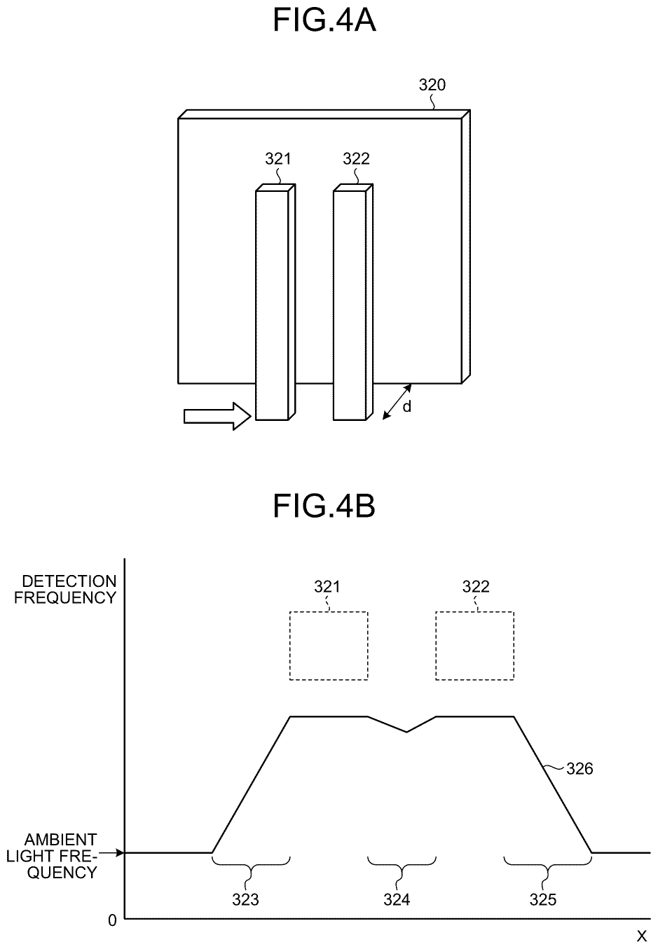

FIG. 4A is a diagram illustrating an example of distance measurement according to the embodiment of the present disclosure. This drawing illustrates an example of a case of performing distance measurement of target objects 320, 321, and 322. It is assumed that the distance is measured from the front side of the drawing. The target objects 321 and 322 are arranged in front of the target object 320 by a distance d. Here, the time-of-flight data 310 at a position of an outlined arrow in the drawing will be considered.

FIG. 4B is a diagram illustrating an example of distance measurement according to the embodiment of the present disclosure. This drawing is obtained by extracting data of a specific Y-axis value from the above-described time-of-flight data 310 at the position of the outlined arrow. The horizontal axis in the drawing represents the X axis. In addition, the vertical axis in the drawing represents the detection frequency. Further, a dashed rectangle in the drawing represents the positions of the target objects 321 and 322. A graph 326 in the drawing is a graph indicating the detection frequency with respect to the X coordinate. In the drawing, “ambient light frequency” represents the frequency of a class that the reflected light does not reach in the time-of-flight histogram. For example, a detection frequency of a histogram generated by the light receiving unit 20 having received ambient light such as sunlight corresponds to the ambient light frequency.

Regions 323, 324, and 325 in the graph 326 are regions corresponding to a “blur” in a visible light image. This region is originally supposed to be a region having the same detection frequency as the ambient light frequency. However, the region corresponds to an error that has occurred in the detection, by the light receiving unit 20, of scattered light, which has resulted from scattering of reflected light of the target objects 321 and 322. Hereinafter, the data in these regions is referred to as a blur.

Occurrence of such a blur leads to detection of a distance measurement value of a different shape for the target object 321, causing an occurrence of an error in the distance measurement value. To handle this, the information processing device 100 of the present disclosure removes this blur to reduce the error of the measurement value.

### [Configuration of Object Boundary Detection Unit]

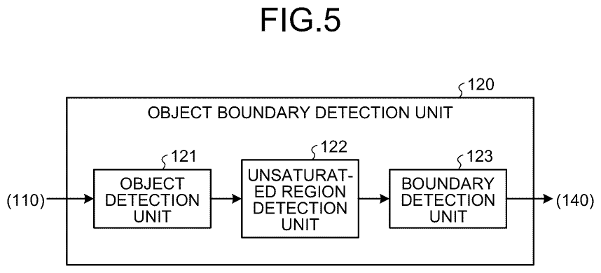

FIG. 5 is a diagram illustrating a configuration example of an object boundary detection unit according to a first embodiment of the present disclosure. The drawing is a diagram illustrating a configuration example of the object boundary detection unit 120. The object boundary detection unit 120 in the drawing includes an object detection unit 121, an unsaturated region detection unit 122, and a boundary detection unit 123.

The object detection unit 121 detects a region of an object from the time-of-flight data group 300. The object detection unit 121 detects a protrusion (peak) of the histogram 313 described in FIG. 3B, enabling detection of the region of the object.

The unsaturated region detection unit 122 detects a region where the detection frequency in the vicinity of the object detected by the object detection unit 121 is unsaturated. As described above, the light receiving unit 20 integrates the detection frequencies of the plurality of reflected light beams accompanying the emission of the plurality of emitted light beams, thereby generating the histogram. When the detection frequency reaches the upper limit due to the integration of the detection frequencies, the detection frequency of the class is saturated. The unsaturated region detection unit 122 detects an unsaturated region, which is not in a saturated state, and outputs the detected unsaturated region to the object boundary detection unit 120.

The boundary detection unit 123 detects the boundary of the object based on the unsaturated region detected by the unsaturated region detection unit 122. The boundary of the detected object is output to the correction unit 140.

### [Object Boundary Detection]

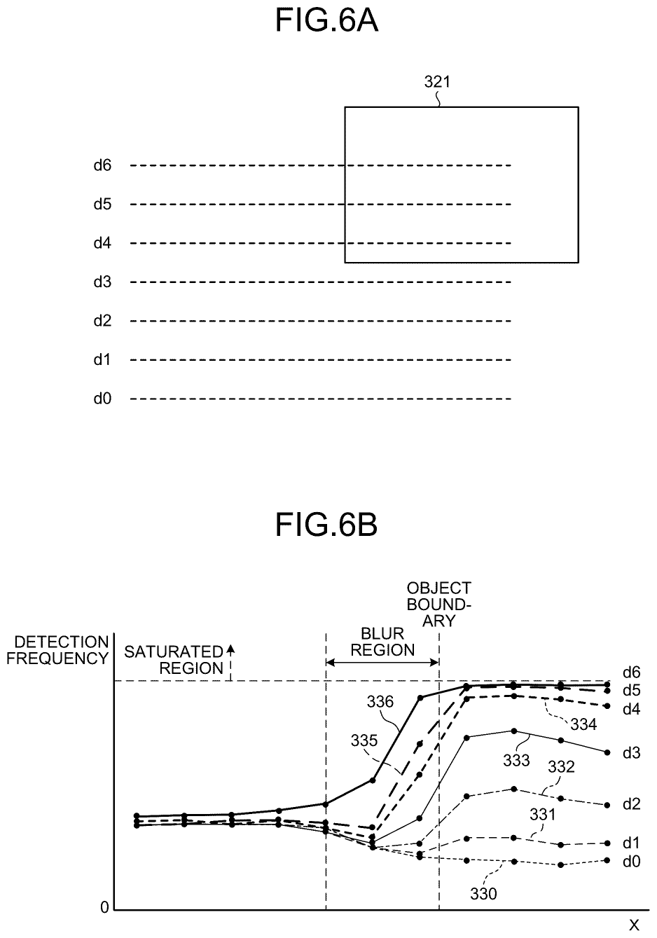

FIGS. 6A and 6B are diagrams illustrating an example of object boundary detection according to the first embodiment of the present disclosure. The object boundary detection will be described using the target object 321 in FIG. 6A as an example. FIG. 6A is a top view of the target object 321. Dotted lines “d0” to “d6” in the drawing represent the positions in the depth direction of the plurality of pieces of time-of-flight data 310 in the vicinity of the front surface of the target object 321. X-axis data at the positions “d0” to “d6” are illustrated in FIG. 6B. The horizontal axis in the drawing represents the X axis. The vertical axis in the drawing represents the detection frequency. A dashed line horizontal to the X axis in the drawing represents a boundary of the saturated region. A dashed line perpendicular to the X axis in the drawing represents an object boundary of the target object 321 and the range of the blur region.

A dashed line graph 330 in the drawing represents a graph of the detection frequency of do. A dotted line graph 331 in the drawing represents a graph of the detection frequency of d1. A one-dot chain line graph 331 in the drawing represents a graph of the detection frequency of d2. A solid line graph 333 in the drawing represents a graph of the detection frequency of d3. A thick dashed line graph 334 in the drawing represents a graph of the detection frequency of d4. A thick dotted line graph 335 in the drawing represents a graph of the detection frequency of d5. A thick solid line graph 336 in the drawing represents a graph of the detection frequency of d6.

The graphs 330 and 331 are the time-of-flight data 310 away from the target object 321, and thus each has detection frequency corresponding to the ambient light frequency. The region is an unsaturated region, which is not saturated. Since the graphs 334 to 336 are the time-of-flight data 310 involving the target object 321, the region involving the target object 321 is substantially saturated. In the graphs 334 to 336, a blur occurs in the vicinity of the outside in the vicinity of the boundary of the object. Graphs 332 and 333 in the drawing correspond to unsaturated regions. The boundary of the object is detected using the data of the detection frequencies of the graphs 332 and 333.

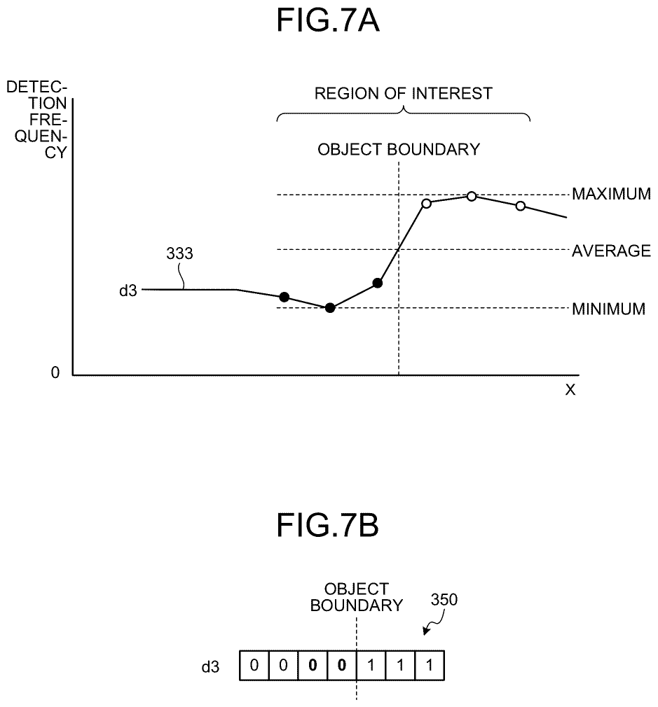

FIG. 7A is a diagram illustrating an example of object boundary detection according to the first embodiment of the present disclosure. The object boundary detection will be described using the graph 333 in FIG. 6B as an example. First, a region of interest is set. The region of interest is a region in the vicinity of the boundary of the object and is a region including the boundary of the object. The region of interest can be detected based on the end of the saturated region in the graph 334 indicating a saturated state, or the like. For example, a region within five taps with respect to the end of the region can be set as the region of interest.

Next, detection of the maximum detection frequency and the minimum detection frequency in the time-of-flight data 310 of “d3” corresponding to the graph 333 of the region of interest is performed, and an average of the frequencies detected is calculated. The position where the average and the graph 333 intersect can be detected as the boundary of the object. In the drawing, filled circles are data involving the outer region of the object. On the other hand, outlined circles indicate data of regions included in the object. Note that the boundary detection unit 123 can add a label indicating the boundary of the object to the time-of-flight data 310, such as “d3”. Hereinafter, this label is referred to as a spatial label.

FIG. 7B is a diagram illustrating an example of object boundary detection according to the first embodiment of the present disclosure. This drawing is a diagram illustrating an example of a spatial label 350. The spatial label 350 indicates a region included in the object in the detection frequency of the region of interest. A portion having a value “1” of the spatial label 350 represents a region included in the object. On the other hand, a portion having a value “0” of the spatial label 350 represents a blur region.

### [Correction]

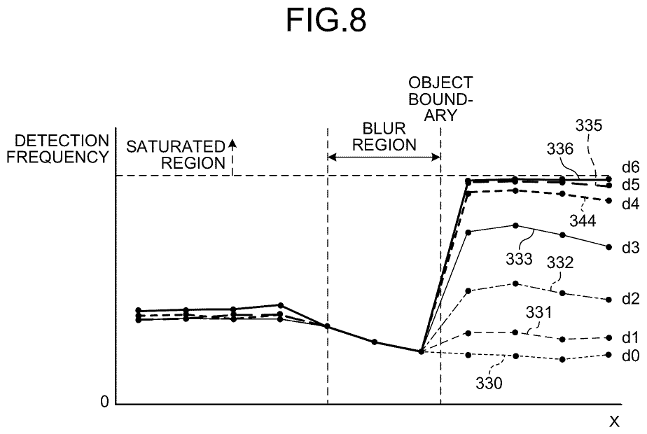

FIG. 8 is a diagram illustrating an example of correction according to the first embodiment of the present disclosure. The drawing is a diagram illustrating correction of the time-of-flight data group 300 performed by the correction unit 140. The correction unit 140 performs correction based on the object boundary detected by the boundary detection unit 123. Specifically, the correction unit 140 sets a region outside the boundary of the object in the above-described region of interest as a blur region, and performs correction by replacing the detection frequency of the time-of-flight data 310 in the blur region with the ambient light frequency. In the drawing, the correction unit 140 detects the detection frequency of the time-of-flight data 310 of “d0” corresponding to the graph 330, as the ambient light frequency. The ambient light frequency is used to replace the data of the blur regions of “d1” to “d6”. This makes it possible to remove the blur at the boundary of the object.

### [Processing Procedure]

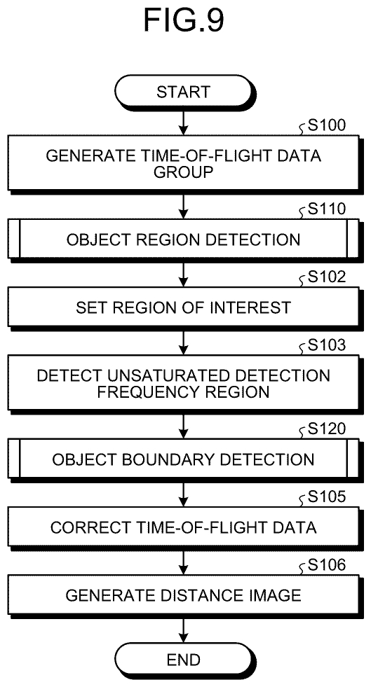

FIG. 9 is a diagram illustrating an example of a processing procedure in information processing according to the first embodiment of the present disclosure. The drawing is a flowchart illustrating a processing procedure of the information processing device 100. First, the distance data generation unit 110 generates a time-of-flight data group (step S100). Next, the object detection unit 121 performs object region detection processing for detecting a region of an object (step S110). Next, the unsaturated region detection unit 122 sets a region of interest in the region of the object (step S102). Next, the unsaturated region detection unit 122 detects an unsaturated detection frequency region (step S103). This can be performed by the method described in FIG. 6B. Next, the unsaturated region detection unit 122 performs object boundary detection processing for detecting the boundary of the object (step S120).

Next, the correction unit 140 corrects the time-of-flight data 310 based on the detected boundary (step S106). Next, the distance image generation unit 150 generates a distance image based on the corrected time-of-flight data group 300 (step S106).

### [Object Region Detection Processing Procedure]

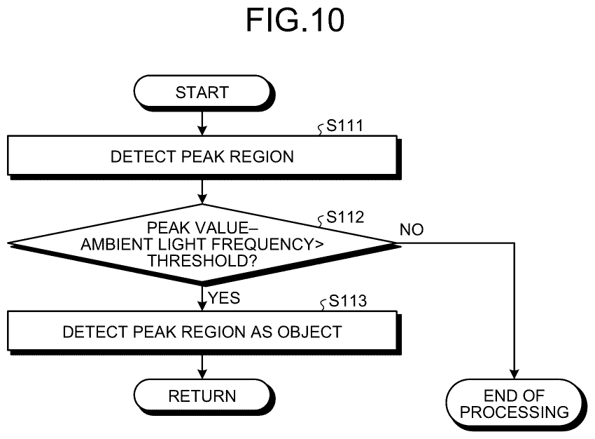

FIG. 10 is a diagram illustrating an example of a processing procedure regarding object region detection processing according to the first embodiment of the present disclosure. First, the object detection unit 121 detects a peak region from the time-of-flight data group 300 (step S111). Next, the object detection unit 121 subtracts the ambient light frequency from the detection frequency of the detected peak, and compares a result of subtraction with a predetermined threshold. When the subtraction result is smaller than the threshold as a result of comparison (step S112, No), the processing ends. In contrast, when the subtraction result is larger than the threshold (step S112, Yes), the object detection unit 121 detects the peak region as the region of the object (step S113). Thereafter, the object detection unit 121 ends the object region detection processing.

### [Object Boundary Detection Processing Procedure]

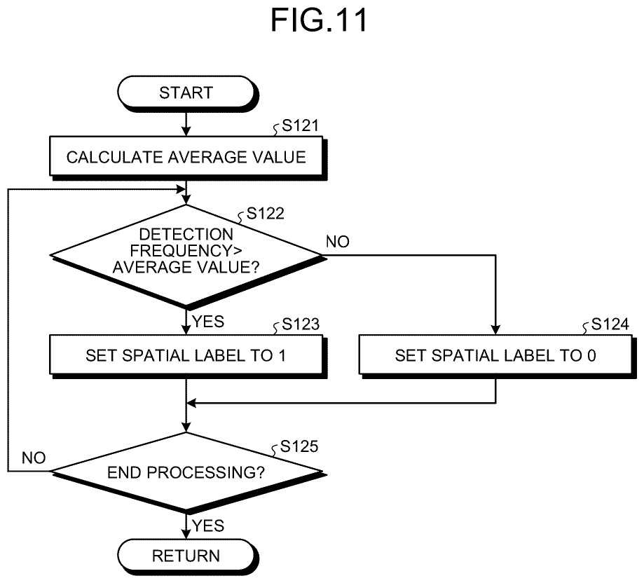

FIG. 11 is a diagram illustrating an example of a processing procedure regarding object boundary detection processing according to the first embodiment of the present disclosure. First, the unsaturated region detection unit 122 calculates an average value of the time-of-flight data 310 in the unsaturated region (step S121). This can be performed by the method described in FIG. 7A (step S121). Next, the detection frequency and the average value are compared for the time-of-flight data 310 of the region of interest. When the detection frequency is larger than the average value as result of comparison (step S122, Yes), the corresponding spatial label is set to the value “1” (step S123), and the processing proceeds to step S125.

In contrast, when the detection frequency is less than the average value (step S122, No), the corresponding spatial label is set to the value “0” (step S124), and the processing proceeds to step S125. In step S125, the unsaturated region detection unit 122 judges whether the processing has ended (step S125). In a case where the processing has been performed for all the detection frequencies (step S125, Yes), the object boundary detection processing ends. In contrast, in a case where the processing has not been performed for all the detection frequencies (step S125, No), the processing of step S122 is performed again.

In this manner, the information processing device 100 according to the first embodiment of the present disclosure detects the blur region in the vicinity of the outside of the boundary of the object and corrects the time-of-flight detection frequency. This makes it possible to reduce the error in the shape of the object in the distance measurement image, leading to improvement in distance measurement accuracy.

### 2. Second Embodiment

The information processing device 100 according to the first embodiment described above detects a single object from the time-of-flight data group 300. In contrast, an information processing device 100 according to a second embodiment of the present disclosure is different from the above-described first embodiment in that it detects a plurality of objects overlapping in a depth direction.

### [Configuration of Distance Measuring Device]

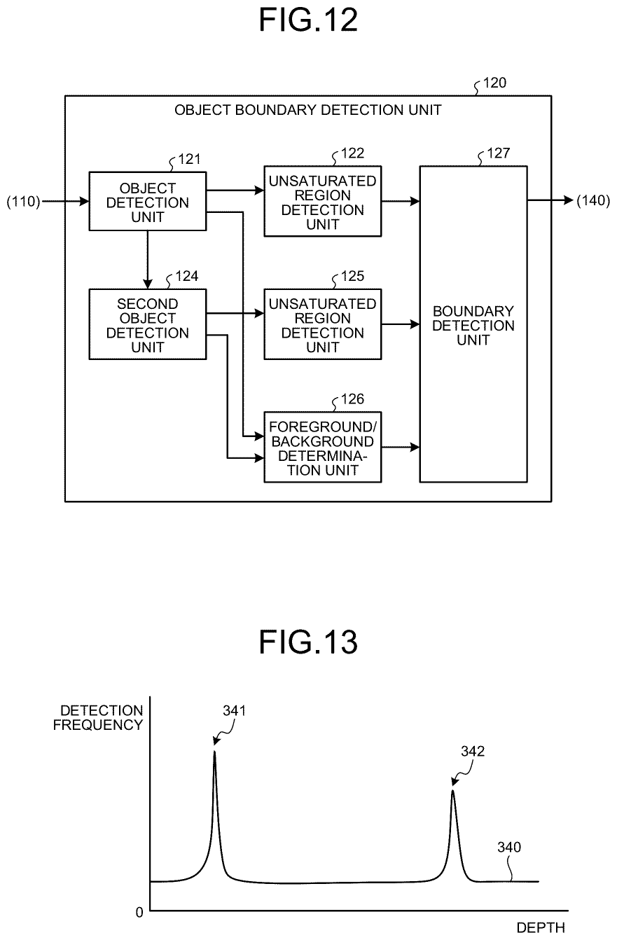

FIG. 12 is a diagram illustrating a configuration example of an object boundary detection unit according to the second embodiment of the present disclosure. The drawing is a diagram illustrating a configuration example of the object boundary detection unit 120. The object boundary detection unit 120 in the drawing is different from the object boundary detection unit 120 in FIG. 1 in including a boundary detection unit 127 instead of the boundary detection unit 123, and further including a second object detection unit 124, an unsaturated region detection unit 125, and a foreground/background determination unit 126.

The second object detection unit 124 detects an object overlapping with the object detected by the object detection unit 121 in the depth direction. The object detected by the second object detection unit 124 is output to the unsaturated region detection unit 125.

The unsaturated region detection unit 125 detects the unsaturated region of the object detected by the second object detection unit 124. The detected unsaturated region is output to the boundary detection unit 123. Note that the unsaturated region detection unit 125 can use a configuration similar to the configuration of the unsaturated region detection unit 122.

The foreground/background determination unit 126 determines the positions, in the depth direction, of the objects individually detected by the object detection unit 121 and the second object detection unit 124. Here, the object on the front side is referred to as a foreground, and the object on the back side is referred to as a background. The foreground/background determination unit 126 determines whether the object detected by each of the object detection unit 121 and the second object detection unit 124 is the foreground or the background. The determination result is output to the boundary detection unit 123.

The boundary detection unit 127 detects the boundary of the object based on the unsaturated region output from the unsaturated region detection unit 122 and the unsaturated region detection unit 125 and based on the foreground/background determination result output from the foreground/background determination unit 126.

### [Detection of Object]

FIG. 13 is a diagram illustrating an example of object detection according to the second embodiment of the present disclosure. The drawing is a diagram illustrating an example of detection of an object by the object detection unit 121 and the second object detection unit 124. The drawing illustrates a histogram (histogram 340) of the detection frequency of a specific pixel in the time-of-flight data group 300, similarly to the histogram 313 of FIG. 3A. The histogram 340 is a histogram having two peaks (a peak 341 and a peak 342). The object detection unit 121 detects an object based on either the peak 341 or the peak 342. The second object detection unit 124 detects an object (second object) based on a peak not detected by the object detection unit 121.

### [Foreground/Background Determination]

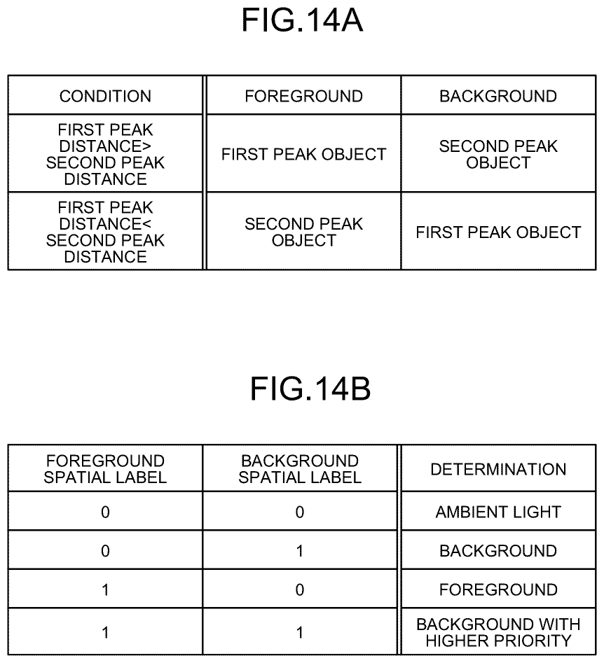

FIG. 14A is a diagram illustrating an example of foreground/background determination according to the second embodiment of the present disclosure. The drawing is a diagram illustrating an example of foreground/background determination performed by the foreground/background determination unit 126. The foreground/background determination unit 126 receives input of object information from the object detection unit 121 and the second object detection unit 124. The foreground/background determination unit 126 performs foreground/background determination based on these pieces of information. In the drawing, the first peak and the second peak are peaks of histograms detected by the object detection unit 121 and the second object detection unit 124, respectively.

As illustrated in the drawing, the foreground/background determination unit 126 performs foreground/background detection based on the distance to each object. In addition, the foreground/background determination unit 126 adds a determination result to the information of the objects detected by the object detection unit 121 and the second object detection unit 124, and outputs the combined information to the boundary detection unit 127. Specifically, a spatial label indicating a determination result is added to each object.

### [Object Boundary Detection]

FIG. 14B is a diagram illustrating an example of object boundary detection according to the second embodiment of the present disclosure. The boundary detection unit 127 performs foreground/background judgment based on the spatial labels of the objects individually detected by the object detection unit 121 and the second object detection unit 124. When both the foreground spatial label and the background spatial label have the value “0”, it is judged as the ambient light frequency. When either the foreground spatial label or the background spatial label has the value “1”, the foreground background judgment is performed based on the spatial label. When both the foreground spatial label and the background spatial label have the value “1”, it is judged as the background.

The boundary detection unit 127 detects boundaries of the plurality of objects. Even in a case where the plurality of objects is close to each other in XY coordinates, the boundaries of the objects are detected using information regarding the foreground and the background, representing the positional relationship in the depth direction.

The configuration of the information processing device 100 other than this is similar to the configuration of the information processing device 100 according to the first embodiment of the present disclosure, and thus the description thereof will be omitted.

In this manner, the information processing device 100 according to the second embodiment of the present disclosure can detect the boundary of each object even when a plurality of objects is close to each other in a planar manner.

### 3. Third Embodiment

The information processing device 100 according to the second embodiment described above performs foreground/background detection. In contrast, an information processing device 100 according to a third embodiment of the present disclosure is different from the above-described first embodiment in that a boundary is detected using an average value of detection frequencies.

### [Configuration of Distance Measuring Device]

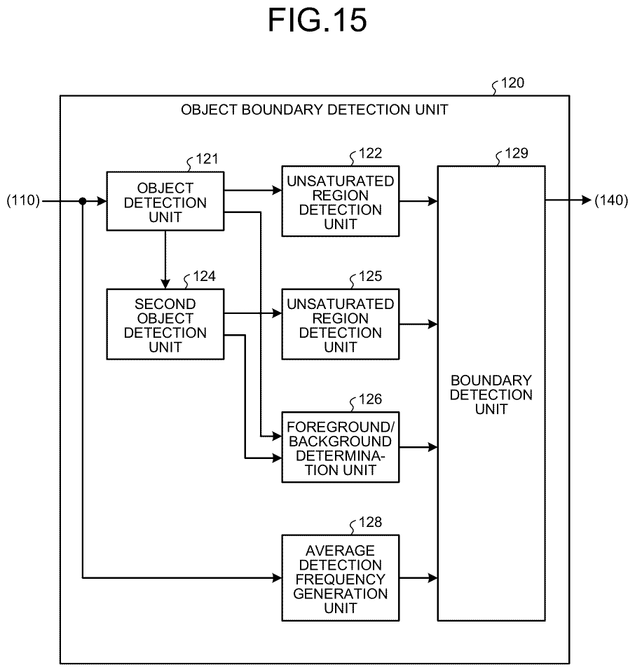

FIG. 15 is a diagram illustrating a configuration example of an object boundary detection unit according to the third embodiment of the present disclosure. The drawing is a diagram illustrating a configuration example of the object boundary detection unit 120. The object boundary detection unit 120 in the drawing is different from the information processing device 100 in FIG. 12 in including a boundary detection unit 129 instead of the boundary detection unit 127 and further including an average detection frequency generation unit 128.

The average detection frequency generation unit 128 generates an average detection frequency. Here, the average detection frequency is data constituted with an average value in the depth direction of the detection frequency for each pixel of the time-of-flight data group 300. When the noise level of the detection frequency is high, the average detection frequency can be used as the ambient light frequency. The generated average detection frequency is output to the boundary detection unit 129.

The boundary detection unit 129 uses the average detection frequency output from the average detection frequency generation unit 128, as the ambient light frequency, so as to detect the boundary of the object. Specifically, the unsaturated detection frequency is detected based on the average detection frequency.

The configuration of the information processing device 100 other than this is similar to the configuration of the information processing device 100 according to the second embodiment of the present disclosure, and thus the description thereof will be omitted.

In this manner, the information processing device 100 according to the third embodiment of the present disclosure generates the average detection frequency to be used as the ambient light frequency. With this configuration, even when the noise level of the detection frequency is high, it is possible to prevent degradation in the object boundary detection accuracy.

### 4. Fourth Embodiment

The information processing device 100 according to the first embodiment described above performs correction by replacing the detection frequency of the blur region with the ambient light frequency. In contrast, an information processing device 100 according to a fourth embodiment of the present disclosure is different from the above-described first embodiment in that a detection frequency of a blur region is restored using a filter.

### [Configuration of Distance Measuring Device]

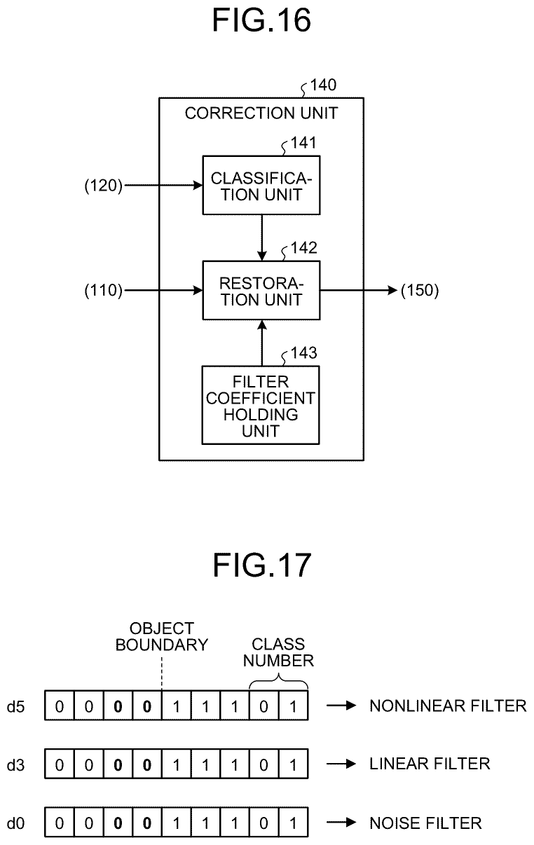

FIG. 16 is a diagram illustrating a configuration example of a correction unit according to the fourth embodiment of the present disclosure. The drawing is a diagram illustrating a configuration example of a correction unit 140. The correction unit 140 in the drawing includes a classification unit 141, a restoration unit 142, and a filter coefficient holding unit 143.

The classification unit 141 classifies the time-of-flight data 310 in the vicinity of the object in the region of interest. The classification unit 141 outputs a result of the classification to the restoration unit 142. The classification unit 141 can perform classification for each class based on the saturation state of the time-of-flight data 310. Specifically, the classification unit 141 adds a class number label “11” to the time-of-flight data 310 of the detection frequency of the saturated state. In addition, the classification unit 141 adds a class number label “01” to the time-of-flight data 310 of the unsaturated detection frequency. The classification unit 141 adds a class number label “00” to the other time-of-flight data 310.

The restoration unit 142 restores data in the vicinity of the boundary of the object including a blur region. The restoration unit 142 restores the data by performing filtering on the time-of-flight data 310 in the depth direction. Furthermore, the restoration unit 142 selects filtering according to the result of classification performed by the classification unit 141.

For example, the restoration unit 142 performs filtering using a nonlinear filter on the time-of-flight data 310 of the class number label “11”. Furthermore, for example, the restoration unit 142 performs filtering using a linear filter on the time-of-flight data 310 of the class number label “01”. Furthermore, for example, the restoration unit 142 performs filtering using a noise suppression filter on the time-of-flight data 310 of the class number label “00”. By these processes of filtering, the restoration unit 142 can restore data in the vicinity of the object including the blur region. By this restoration process, the time-of-flight data 310 of the blur region can be corrected.

The filter coefficient holding unit 143 stores filter coefficients to be applied to filtering in the restoration unit 142.

### [Classification and Filtering]

FIG. 17 is a diagram illustrating an example of classification and filtering according to the fourth embodiment of the present disclosure. This drawing illustrates classification of the time-of-flight data by the classification unit 141 and corresponding filtering.

The configuration of the information processing device 100 other than this is similar to the configuration of the information processing device 100 according to the first embodiment of the present disclosure, and thus the description thereof will be omitted.

In this manner, the information processing device 100 according to the fourth embodiment of the present disclosure restores and corrects the time-of-flight data 310 of the blur region by filtering. This makes it possible to simplify the processing.

### (Effects)

The information processing device 100 includes the distance data generation unit 110, the object boundary detection unit 120, and the correction unit 140. The distance data generation unit 110 generates the time-of-flight data group 300 including a plurality of pieces of time-of-flight data formed at predetermined distance intervals, each of the plurality of pieces of time-of-flight data being generated based on a time of flight detected based on reflected light emitted from a light source and reflected from a subject and having a configuration in which a detection frequency of the time of flight at a corresponding distance is reflected for each pixel. The object boundary detection unit 120 detects the boundary of the object based on the time-of-flight data group 300. The correction unit 140 corrects the time-of-flight data group 300 based on the detected boundary of the object. This makes it possible to correct data in the vicinity of the boundary of the object, changed by scattering of light generated until reflected light from the object reaches the light receiving unit 20.

Furthermore, the object boundary detection unit 120 may detect the boundary of the object by detecting a region in which the detection frequency is unsaturated in the vicinity of a region in which the detection frequency is saturated. This makes it possible to remove the influence of saturation of the detection frequency.

Furthermore, the object boundary detection unit 120 may detect the boundary of the object based on the average of the detection frequencies of the unsaturated regions.

Furthermore, the correction unit 140 may correct the time-of-flight data group 300 by replacing the detection frequency of the region in the vicinity of the outside of the boundary of the detected object with the detection frequency of a region where the reflected light does not reach. This makes it possible to restore the original detection frequency.

Furthermore, the correction unit 140 may correct the time-of-flight data group 300 by filtering. This makes it possible to restore the original detection frequency.

Furthermore, it is also allowable to further include a distance image generation unit that generates a distance image based on the corrected time-of-flight data group 300. This makes it possible to generate a distance image.

An information processing method includes: generating the time-of-flight data group 300 including a plurality of pieces of time-of-flight data formed at predetermined distance intervals, each of the plurality of pieces of time-of-flight data being generated based on a time of flight detected based on reflected light emitted from a light source and reflected from a subject and having a configuration in which a detection frequency of the time of flight at a corresponding distance is reflected for each pixel; detecting a boundary of an object based on the time-of-flight data group 300; and correcting the time-of-flight data group 300 based on the detected boundary of the object. This makes it possible to correct data in the vicinity of the boundary of the object, changed by scattering of light generated until reflected light from the object reaches the light receiving unit 20.

The effects described in the present specification are merely examples, and thus, there may be other effects, not limited to the exemplified effects.

Note that the present technique can also have the following configurations.

(1)

An information processing device comprising:
a distance data generation unit that generates a time-of-flight data group including a plurality of pieces of time-of-flight data formed at predetermined distance intervals, each of the plurality of pieces of time-of-flight data being generated based on a time of flight detected based on reflected light emitted from a light source and reflected from a subject and having a configuration in which a detection frequency of the time of flight at a corresponding distance is reflected for each pixel;
an object boundary detection unit that detects a boundary of an object based on the time-of-flight data group; and
a correction unit that corrects the time-of-flight data group based on the detected boundary of the object.
   (2)

The information processing device according to the above (1), wherein the object boundary detection unit detects the boundary of the object by detecting an unsaturated region in which the detection frequency is not saturated in a vicinity of a region in which the detection frequency is saturated.

(3)

The information processing device according to the above (2), wherein the object boundary detection unit detects the boundary of the object based on an average of detection frequencies of the unsaturated region.

(4)

The information processing device according to any one of the above (1) to (3), wherein the correction unit corrects the time-of-flight data group by replacing the detection frequency of the region in the vicinity of outside of the boundary of the detected object with the detection frequency of a region where the reflected light does not reach.

(5)

The information processing device according to any one of the above (1) to (3), wherein the correction unit corrects the time-of-flight data group by filtering.

(6)

The information processing device according to the above (1), further comprising a distance image generation unit that generates a distance image based on the corrected time-of-flight data group.

(7)

An information processing method comprising:
generating a time-of-flight data group including a plurality of pieces of time-of-flight data formed at predetermined distance intervals, each of the plurality of pieces of time-of-flight data being generated based on a time of flight detected based on reflected light emitted from a light source and reflected from a subject and having a configuration in which a detection frequency of the time of flight at a corresponding distance is reflected for each pixel;
detecting a boundary of an object based on the time-of-flight data group; and
correcting the time-of-flight data group based on the detected boundary of the object.

### REFERENCE SIGNS LIST

1 DISTANCE MEASURING DEVICE
10 LIGHT SOURCE UNIT
20 LIGHT RECEIVING UNIT
100 INFORMATION PROCESSING DEVICE
110 DISTANCE DATA GENERATION UNIT
120 OBJECT BOUNDARY DETECTION UNIT
121 OBJECT DETECTION UNIT
122, 125 UNSATURATED REGION DETECTION UNIT
123, 127, 129 BOUNDARY DETECTION UNIT
124 SECOND OBJECT DETECTION UNIT
126 FOREGROUND/BACKGROUND DETERMINATION UNIT
128 AVERAGE DETECTION FREQUENCY GENERATION UNIT
140 CORRECTION UNIT
141 CLASSIFICATION UNIT
142 RESTORATION UNIT
150 DISTANCE IMAGE GENERATION UNIT

1. An information processing device comprising:
a distance data generation unit that generates a time-of-flight data group including a plurality of pieces of time-of-flight data formed at predetermined distance intervals, each of the plurality of pieces of time-of-flight data being generated based on a time of flight detected based on reflected light emitted from a light source and reflected from a subject and having a configuration in which a detection frequency of the time of flight at a corresponding distance is reflected for each pixel;
an object boundary detection unit that detects a boundary of an object based on the time-of-flight data group; and
a correction unit that corrects the time-of-flight data group based on the detected boundary of the object.

2. The information processing device according to claim 1, wherein the object boundary detection unit detects the boundary of the object by detecting an unsaturated region in which the detection frequency is not saturated in a vicinity of a region in which the detection frequency is saturated.

3. The information processing device according to claim 2, wherein the object boundary detection unit detects the boundary of the object based on an average of detection frequencies of the unsaturated region.

4. The information processing device according to claim 1, wherein the correction unit corrects the time-of-flight data group by replacing the detection frequency of the region in the vicinity of outside of the boundary of the detected object with the detection frequency of a region where the reflected light does not reach.

5. The information processing device according to claim 1, wherein the correction unit corrects the time-of-flight data group by filtering.

6. The information processing device according to claim 1, further comprising a distance image generation unit that generates a distance image based on the corrected time-of-flight data group.

7. An information processing method comprising:
generating a time-of-flight data group including a plurality of pieces of time-of-flight data formed at predetermined distance intervals, each of the plurality of pieces of time-of-flight data being generated based on a time of flight detected based on reflected light emitted from a light source and reflected from a subject and having a configuration in which a detection frequency of the time of flight at a corresponding distance is reflected for each pixel;
detecting a boundary of an object based on the time-of-flight data group; and
correcting the time-of-flight data group based on the detected boundary of the object.
